(19) United States
(12) Patent Application Publication
(10) Pub. No.: US 2009/0132860 A1
(43) Pub. Date: May 21, 2009

(54) SYSTEM AND METHOD FOR RAPIDLY DIAGNOSING BUGS OF SYSTEM SOFTWARE

(75) Inventors: Qing-Biao LIU, Tianjin (CN); Qin-Ping ZHUANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/943,985

(22) Filed: Nov. 21, 2007

(51) Int. Cl. G06F 11/00

(52) U.S. Cl. 714/38; 714/E11.001

(57) ABSTRACT

A system and a method for rapidly diagnosing bugs of system software are apply for rapidly localizing a system program fault that causes a system error and then feeding back to a subscriber. First, according to the subscriber's requirement, a program of system fault analysis standard is preset and written into the system. Next, a plurality of fault insertion points is added into a program module of the system according to the subscriber's requirement for the precision of the fault analysis result. Then, fault management information is generated at the fault insertion points during the running process of the system program, and the management information is monitored for collecting relevant system fault data. After that, the collected system fault data is analyzed in real time through the program of system fault analysis standard, so as to obtain the minimum fault set for causing the system error.

### BACKGROUND OF THE INVENTION

1. Field of the Invention

The present invention relates to a system and a method for rapidly diagnosing bugs of system software, and more particularly to a system and a method for rapidly localizing a system program fault that causes a system error and then feeding back to a subscriber.

2. Related Art

Currently, various problems may occur in an operating system (OS), such as damages of hardware, allocation errors, or software bugs. In order to cater to different users' different requirements, firstly, a software designer has to be clear about a user's demands, then plans the software requirements, defines the system mode of the software, and then expresses the relation between each functional mode by means of a tree diagram, so as to identify and determine the impacts, data source, and safety between different functional modes. Next, the software designer starts to work on the main architecture of each functional mode, and then plans and designs each functional mode in details. After the planning and designing process, the software designer starts writing program codes, and the program codes must be written according to the functional modes established based upon the theme architecture and detailed design, so as to make the function of the software meet the user's requirements. After encoding, software bugs should be diagnosed, and then it is diagnosed whether the execution result of a program meets the original design requirement. At this time, the software designer must determine whether the input and output data of each functional mode meets the original requirement or not. Besides, the whole performance of the system should also be diagnosed. Even if the function of the software is satisfactory, but its executing is satisfactory, but its executing speed is very slow, the software still cannot meet the user's requirement.

During the encoding and fault diagnosis of a software program, the most complicated step is debugging. The software designer must detect every bug in the software, and rapidly diagnose the software bugs in the simplest way. Therefore, the software designer usually diagnoses the common faults of the software program according to his/her own experience. If the software designer fails to diagnose all the bugs in the software, once the software is submitted to the user, many undiagnosed software bugs may occur during the test of the software conducted by the user. Further, it takes plenty of time for the software designer to diagnose the functions of the software one by one. Moreover, if only each single function of the software is diagnosed, the whole performance of the software cannot be fully diagnosed. In some circumstances, an experienced software tester can quickly localize the cause of a problem or fault. However, sometimes, even the experienced tester has to spend hours or days on precisely localizing the cause of a problem or fault in a software. Therefore, the time for diagnosing software failures or bugs is prolonged, so the cost for maintenance and update of the software is increased.

### SUMMARY OF THE INVENTION

In order to solve the above problems and defects in the conventional art, the present invention is directed to a system and a method for rapidly diagnosing bugs of system software, applicable for rapidly localizing a system program fault that causes a system error and feeding back to a subscriber.

According to a preferred embodiment of the present invention, a system for rapidly diagnosing bugs of system software includes: an operating system unit, a plurality of functional modules, a hardware unit, a fault monitoring module, a fault analysis module, and a minimum fault set record and feedback module.

The operating system unit is used for writing a program of system fault analysis standard into the system, and adding a plurality of fault insertion points into a program module of the system according to the requirement for precision of fault analysis result. The functional modules are used for transmitting fault management information generated at the fault insertion points of the functional modules during a running process of a system program to the fault monitoring module. The hardware unit is used for transmitting fault management information generated at the fault insertion point of a hardware program module during the running process of the system program to the fault monitoring module via the operating system unit. The fault monitoring module is used for receiving the fault management information transmitted by the operating system unit and the functional modules, monitoring the fault management information, and collecting relevant system fault data for being transmitted to the fault analysis module. The fault analysis module is used for analyzing in real time the collected system fault data through the program of system fault analysis standard, so as to obtain a minimum fault set for causing the system error. The minimum fault set record and feedback module is used for recording the minimum fault set into the system log in real time, and feeding back to the subscriber.

The fault analysis module groups a plurality of program tasks running in the system via the program of system fault analysis standard; sorts and gathers the fault data collected at the fault insertion points according to different groups of the program tasks; obtains a minimum fault set for a single task according to the system fault analysis standard; and filters and selects a minimum fault set for the current system according to the system fault analysis standard based upon a topological structure of call relation of the program tasks in the system and the analysis result of the minimum fault set for each single task. The system fault analysis standard is: showing all relevant faults, showing all root faults, and showing an initial critical fault. Moreover, when a plurality of faults appears in a single program task, the initial fault is taken as a critical fault for the single program task.

A method for rapidly diagnosing bugs of system software according to the present invention includes the following steps: presetting and writing a program of system fault analysis standard into the system; adding a plurality of fault insertion points into a program module of the system according to the requirement for the precision of the fault analysis result; generating fault management information at the fault insertion points during a running process of a system program; monitoring the fault management information, and collecting relevant system fault data; analyzing in real time the collected system fault data through the program of system fault analysis standard, so as to obtain a minimum fault set for causing the system error; and recording the minimum fault set into the system log in real time, and feeding back to the subscriber.

A method for rapidly diagnosing bugs of system software according to the present invention further includes the following steps: grouping a plurality of program tasks running in the system; sorting and gathering the fault data collected at the fault insertion points according to different groups of the program tasks, and obtaining a minimum fault set for a single task according to the system fault analysis standard; and filtering and selecting a minimum fault set for the current system according to the system fault analysis standard based upon a topological structure of call relation of the program tasks in the system and the analysis result of the minimum fault set for each single task. Moreover, the system fault analysis standard is: showing all relevant faults, showing all root faults, and showing an initial critical fault. Furthermore, when a plurality of faults appears in a single program task, the initial fault is taken as a critical fault for the single program task.

In view of the above, the advantage of the present invention is as follows.

The system and method for rapidly diagnosing bugs of system software provided in the present invention are capable of rapidly localizing a system program fault that causes a system error and feeding back to a subscriber. According to the present invention, a program of system fault analysis standard is preset and written into the system, and a plurality of fault insertion points is added into a program module of the system according to the requirement for the precision of the fault analysis result, so as to collect fault management information generated at the fault insertion points during the running process of the system program and relevant system fault data, and to obtain the minimum fault set for causing the system error according to the system fault analysis standard. Therefore, the present invention can assist system software testers and software subscribers to rapidly localize the source of the software program fault that causes a system error or failure, thus greatly enhancing the efficiency for diagnosing bugs of system software, alleviating the difficulty in difficulty in localizing the system failure in the conventional art, and shortening the time spent on localizing the system error.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a system for rapidly diagnosing bugs of system software according to the present invention;

FIG. 2 is a graph showing the topological structure relation of a plurality of program tasks in the present invention;

FIG. 3 is a flow chart of a method for rapidly diagnosing bugs of system software according to the present invention; and

FIG. 4 is a flow chart of sub-steps for a single step in the method shown in FIG. 3.

### DETAILED DESCRIPTION OF THE INVENTION

Preferred embodiments of the present invention will be illustrated below with reference to the accompanying drawings.

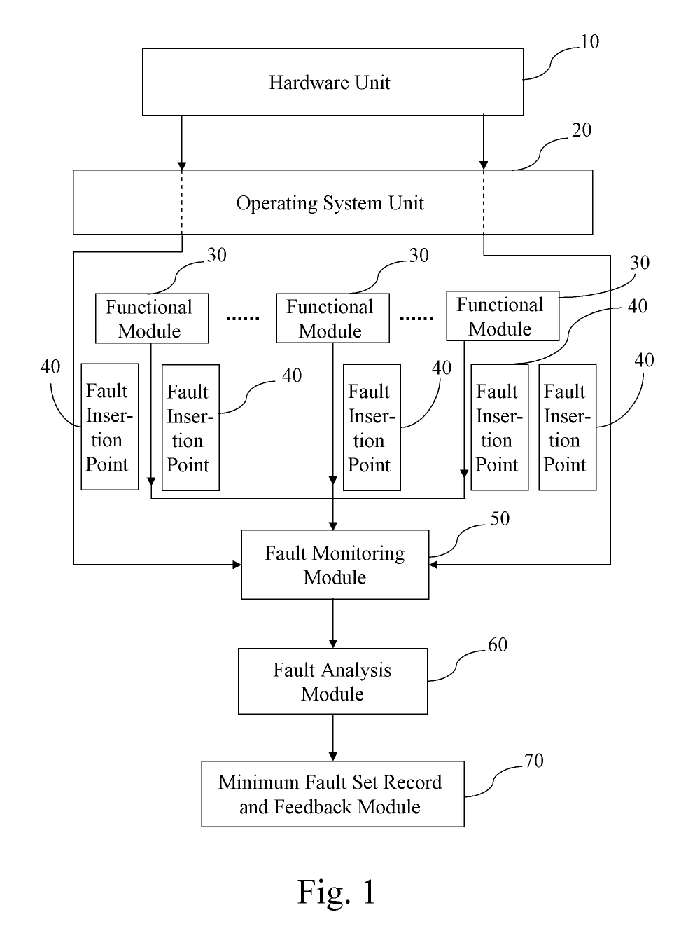

Referring to FIG. 1, it is a block diagram of a system for rapidly diagnosing bugs of system software according to the present invention. The system is applicable for rapidly localizing a system program fault that causes a system error and feeding back to a subscriber. The system includes an operating system unit 20, a plurality of functional modules 30, a hardware unit 10, a fault monitoring module 50, a fault analysis module 60, and a minimum fault set record and feedback module 70.

The operating system unit 20 is used for writing a program of system fault analysis standard into the system, and adding a plurality of fault insertion points 40 into a program module of the system according to the requirement for the precision of the fault analysis result. The functional modules 30 are used for transmitting fault management information generated at the fault insertion points 40 of the functional modules 30 during the running process of the system program to the fault monitoring module 50. The hardware unit 10 is used for transmitting fault management information generated at the fault insertion point 40 of a hardware program module during the running process of the system program to the fault monitoring module 50 via the operating system unit 20 in an interrupt mode. The fault monitoring module 50 is used for receiving the fault management information transmitted by the operating system unit 20 and the functional modules 30, monitoring the fault management information, and collecting relevant system fault data for being transmitted to the fault analysis module 60. The fault analysis module 60 is used for analyzing in real time the collected system fault data through the program of system fault analysis standard, so as to obtain a minimum fault set for causing the system error. The minimum fault set record and feedback module 70 is used for recording the minimum fault set into the system log in real time, and feeding back to the subscriber.

The fault analysis module 60 groups a plurality of program tasks running in the system via the program of system fault analysis standard; sorts and gathers the fault data collected at the fault insertion points 40 according to different groups of the program tasks; and obtains a minimum fault set for a single task according to the system fault analysis standard. The process of obtaining the minimum fault set for a single task is described as follows.

It is assumed that a program task OAM_xxx1 needs to call three steps. If the three steps are required to be executed successfully one by one, a fault information collection shown in the following table is obtained.

->Job:OAM_xxx1, Start, PID:26, JobID:0012-3242-234234-234234,
All Step:3
->Job:OAM_xxx1, process, Step:1, begin,
JobID:0012-3242-234234-234234
->Module:HDD module, PID:26, File:hdd write.c,
Func:hdd write a block, Line:596, Error message:write hdd2 error!
->Job:OAM_xxx1, process, Step:1, end,
JobID:0012-3242-234234-234234
->Job:OAM_xxx1, process, Step:2, begin,
JobID:0012-3242-234234-234234
->Module:LVM_module, PID:26, File:lvm_create.c,
Func:lvm_create_inner, Line:596, Error message:lvm4 create error!
->Job:OAM_xxx1, process, Step:2, end,
JobID:0012-3242-234234-234234
->Job:OAM_xxx1, process, Step:3, begin,
JobID:0012-3242-234234-234234
->Module:RAID_module, PID:26, File:raid write.c,
Func:raid_write_a_block, Line:596, Error_message:
RAID write_a_block come to an error!
->Module:RAID_module, PID:26, File:raid write.c,
Func:raid_write_a_block, Line:666, Error_message:
RAID write_a_block free memory error!
->Module:RAID_module, PID:26, File:raid_write.c, Func:hdd_write,
Line:256, Error_message:Raid write error!
->Job:OAM_xxx1, process, Step:3, end,
JobID:0012-3242-234234-234234
->Job:OAM_xxx1, Stop, PID:26, JobID:0012-3242-234234-234234

Then, by analyzing the fault information collection shown in the table according to the system fault analysis standard, a minimum fault set for the task can be obtained as follows:

->Module: HDD_module, PID: 26, File: hdd_write.c, Func: hdd_write_a_block, Line: 596, Error_message: write hdd2 error!

Of course, the specific expression of the minimum fault set for the single task does not have to be the same as the above, and the above expression is only taken as a simple illustration for the function. Of course, the subscriber may want to obtain all the fault or error information of the task, which can be achieved through the preset system fault analysis standard according to the subscriber's requirement.

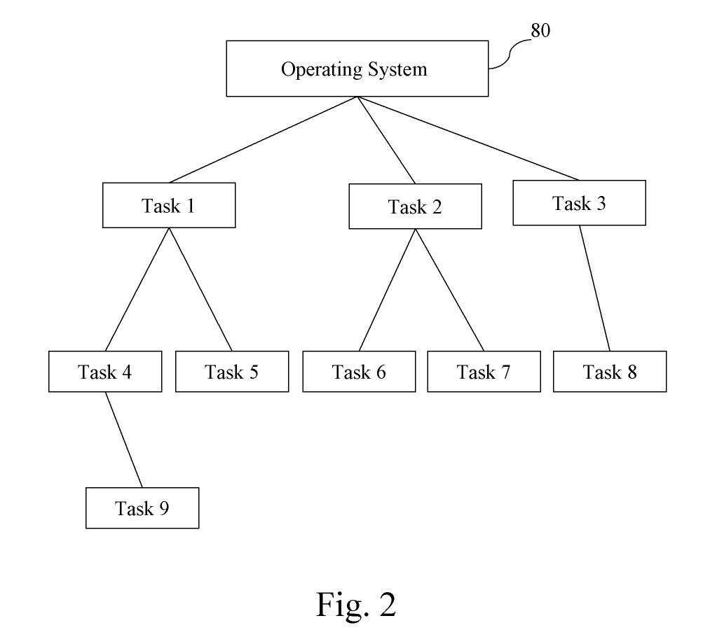

Next, the minimum fault set for the plurality of program tasks is generated based on the minimum fault set for the above single task. Meanwhile, the minimum fault set for the current system can only be generated according to the topological structure of call relation of the plurality of program tasks in the system. FIG. 2 is a graph showing the topological structure relation of a plurality of program tasks in the present invention. The fault analysis module 60 groups the plurality of program tasks running in the operating system 80 through the program of system fault analysis standard, and for example, the operating system 80 is divided into a plurality of program tasks, such as Task 1, Task 2, and Task 3. Then, each single task: Task 1, Task 2, and Task 3, is further grouped in sequence, such that Task 1 is divided into Task 4 and Task 5, Task 2 is divided into Task 6 and Task 7, Task 3 is divided into Task 8, and finally Task 4 is divided into Task 9, and thereby, a graph of the topological structure relation of a plurality of program tasks is obtained. Then, the fundamental fault is filtered and selected according to the system fault analysis standard based upon a topological structure of call relation of the program tasks in the system and the analysis result of the minimum fault set for each single task. Moreover, it should be noted that, the minimum fault set of the plurality of program tasks should be generated based upon the scanning of the fundamental source code.

An example is given below for illustration. It is assumed that Tasks 1, 4, 5, 9 in FIG. 2 may have the following logic structures for execution:

```
Task 1
  Fault_occurred_1_in_task_1
  Task_4
  Fault_occurred_2_in_task_2
  Task_5
Task 4
  Fault_occurred_1_in_task_4
  Task_9
  Fault_occurred_2_in_task_4
Task 5
  Fault_occurred_1_in_task_5
  Fault_occurred_2_in_task_5
Task 9
  Fault_occurred_1_in_task_9
  Fault_occurred_2_in_task_9
```

Under the circumstance that various fault selections may become possible due to the appearance of different faults, in principle, when the system fault analysis standard is set, if a plurality of faults appears in a single program task, an initial fault should be defined as a critical fault of the program task.

For example:

as for the above faults occurred in Tasks 1, 4, 5, 9, if the following faults appear at the same time:

Fault_occurred_1_in_task_9

Fault_occurred_2_in_task_4

Fault_occurred_2_in_task_5

It is certain that the critical fault should be: Fault_occurred_1_in_task_9, and the minimum fault set for Tasks 1, 4, 5, 9 is the critical fault. In some circumstances, the subscriber may want to take the sum of the above three faults as the minimum fault set, which can be achieved through the preset system fault analysis standard according to the subscriber's requirement.

Moreover, the minimum fault set of the system program faults for causing the system error can also be determined and localized through the following coding principle. It is assumed that an application programming interface (API) provided by the system is named: _interface_1 which calls interfaces of three modules:

_raid_mod_interface_x;

_lvm_mod_interface_y;

_hdd_mod_interface_z, and has some processing flows of its own. The processing flows of the API _interface_1 and _raid_mod_interface_x, _lvm_mod_interface_y, _hdd_mod_interface_z may all have faults. It is assumed that fault information as shown in the following table is generated in the API_interface_1 according to the program processing sequence:

| Serial | | | | | line |
|---|---|---|---|---|---|
| Num- | | Module Name for Causing the | | Function | num- |
| ber | Module Name | Fault | File Name | Name | ber |
| 1 | raid_mod_interface_x_{—} | NULL | Raid_sub.c | Func1 | 404 |
| | sub_mod_1 | | | | |
| 2 | raid_mod_interface_x | raid mod_interface_x_sub_mod_1 | Raid.c | Func2 | 202 |
| 3 | _interface | raid_mod_interface_x | Api.c | Interface_1 | 100 |
| 4 | _interface | NULL | Api.c | Interface_1 | 110 |
| 5 | _interface | NULL | Api.c | Interface_1 | 120 |
| 6 | hdd_mod_interface_z_{—} | NULL | Hdd_sub.c | Func3 | 500 |
| | sub_mod2 | | | | |
| 7 | hdd_mod_interface_z | hdd_mod_interface_z_sub_mod2 | Hdd.c | Func4 | 300 |
| 8 | _interface | hdd_mod_interface_z | Api.c | Interface_1 | 160 |

As such, the desired result of the system fault analysis can be obtained through the system fault analysis standard according to the fault information listed in the above table. If the system fault analysis standard is only preset for the initial critical fault that causes a system failure or error, a program or an allocation file of the system fault analysis standard is written into the system before hand, so as to conclude the result of the system fault analysis required by the subscriber. The system fault analysis standard is at least one of the following three modes or any combination thereof. 1. showing all relevant faults; 2. showing all root faults; 3. showing an initial critical fault. If the first mode is adopted for the above example, the obtained minimum fault set is all the fault information listed in the above table. If the second and/or third mode is adopted, the following circumstances should be analyzed first:

1. Faults 3, 4, 5, 8 are those faults occurring in the API interface (as the module name for Faults 3, 4, 5, 8 is _interface, they occur in the module where the API _interface_1 belongs to).

2. Faults 4, 5 occur during the internal processing of the interface itself. As the module names for causing the faults are: NULL, NULL (0) indicates that the reason for causing the faults lies in the module itself.

3. It can be easily derived from the two items of the module name and the module name for causing the faults that, faults 1, 2, 3 are actually one fault. The basic reason for the fault lies in the line numbered 404 in the function Func1 of Raid_sub.c in a sub-module raid_mod_interface_x_sub_mod_1 of raid caused by a certain reason. Faults 2 and 3 are caused by fault 1, such that the fault information should be integrated for the second and/or third mode, so as to integrate the three faults (faults 1, 2, 3) into fault 1.

4. Faults 6, 7, 8 can be analyzed in the same way as faults 1, 2, 3, and the details will not be described herein again.

For the second circumstance, the serial number set of the faults after integration is {1, 4, 5, 6}, and the minimum fault set is generated according to the occurrence sequence for all the root faults. For the third circumstance, fault 1 in the above analyzed fault set {1, 4, 5, 6} is the initial critical fault, so that the minimum fault set is fault 1. Many faults may occur in the above system, and the call relation between the modules is complicated. Sometimes, one module may be called by several different APIs, so the faults may be classified in the following manner:

1. A topological graph of the call relation between the modules is utilized to guide the fault tracing process in the module, and then the topological structure relation of the module is illustrated according to the module name and the module name that causes the fault.

2. Each fault is allocated with a current progress ID number, and the particular API that finally calls the fault can be figured out according to the ID number, so it is easy to gather all the relevant faults called by this API for analysis.

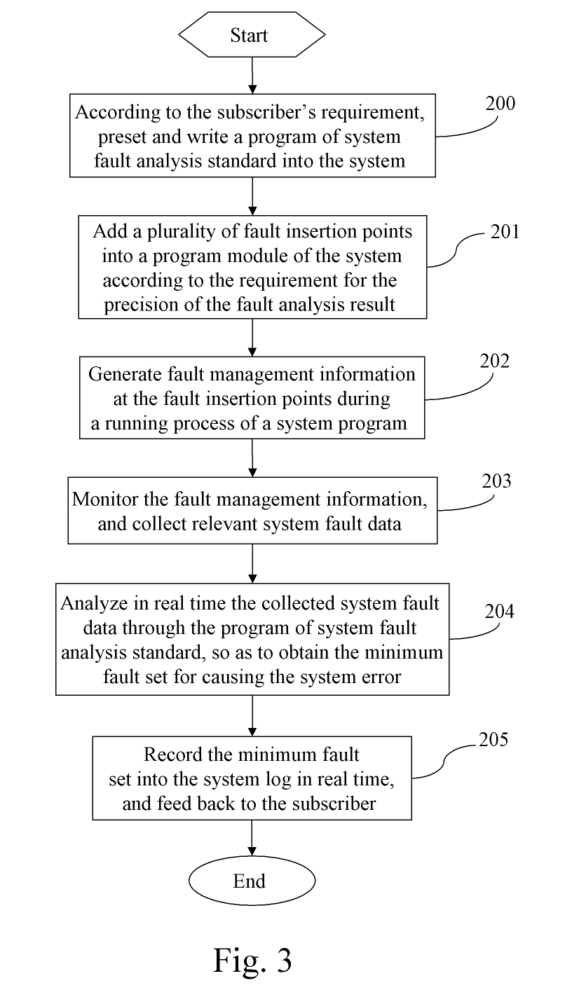

Referring to FIG. 3, it is a flow chart of a method for rapidly diagnosing bugs of system software according to the present invention. In FIG. 3, the method for rapidly diagnosing bugs of system software according to the present invention includes following steps: according to the subscriber's requirement, presetting and writing a program of system fault analysis standard into the system (Step 200); adding a plurality of fault insertion points into a program module of the system according to the requirement for the precision of the fault analysis result (Step 201); generating fault management information at the fault insertion points during a running process of a system program (Step 202); monitoring the fault management information, and collecting relevant system fault data (Step 203); analyzing in real time the collected system fault data through the program of system fault analysis standard, so as to obtain a minimum fault set for causing the system error (Step 204); and recording the minimum fault set into the system log in real time, and feeding back to the subscriber (Step 205).

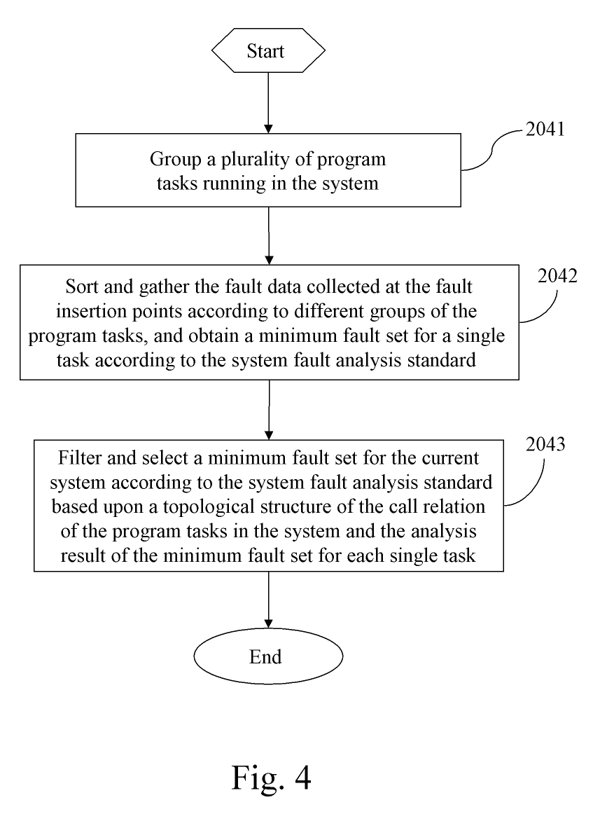

As shown in FIG. 4, Step 204 in the above method for rapidly diagnosing bugs of system software provided by the present invention further includes the following steps: grouping a plurality of program tasks running in the system (Step 2041); sorting and gathering the fault data collected at the fault insertion points according to different groups of the program tasks, and obtaining a minimum fault set for a single task according to the system fault analysis standard (Step 2042); and filtering and selecting a minimum fault set for the current system according to the system fault analysis standard based upon a topological structure of the call relation for the program tasks in the system and the analysis result of the minimum fault set for each single task (Step 2043). Moreover, the system fault analysis standard is one mode of the following three modes or any combination thereof, namely, showing all relevant faults, showing all root faults, and showing an initial critical fault.

Furthermore, when a plurality of faults appears in the above single program task, the initial fault is taken as the critical fault for the single program task.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for rapidly diagnosing bugs of system software, applicable for rapidly localizing a system program fault that causes a system error and then feeding back to a subscriber, the system comprising: an operating system unit, a plurality of functional modules, a hardware unit, a fault monitoring module, a fault analysis module, and a minimum fault set record and feedback module, wherein:
the operating system unit, for writing a program of system fault analysis standard into the system, and adding a plurality of fault insertion points into a program module of the system according to the requirement for the precision of fault analysis result;
the functional modules, for transmitting fault management information generated at the fault insertion points of the functional modules during a running process of a system program to the fault monitoring module;
the hardware unit, for transmitting fault management information generated at the fault insertion point of a hardware program module during a running process of a system program to the fault monitoring module via the operating system unit;
the fault monitoring module, for receiving the fault management information transmitted by the operating system unit and the functional modules, monitoring the fault management information, and collecting relevant system fault data for being transmitted to the fault analysis module;
the fault analysis module, for analyzing in real time the collected system fault data through the program of system fault analysis standard, so as to obtain a minimum fault set for causing the system error; and
the minimum fault set record and feedback module, for recording the minimum fault set into the system log in real time, and feeding back to the subscriber.

2. The system for rapidly diagnosing bugs of system software as claimed in claim 1, wherein the fault analysis module groups a plurality of program tasks running in the system via the program of system fault analysis standard; sorts and gathers the fault data collected at the fault insertion points according to different groups of the program tasks; obtains a minimum fault set for a single task according to the system fault analysis standard; and filters and selects a minimum fault set for the current system according to the system fault analysis standard based upon a topological structure of call relation among the program tasks in the system and the analysis result of the minimum fault set for each single task.

3. The system for rapidly diagnosing bugs of system software as claimed in claim 1, wherein the system fault analysis standard is: showing all relevant faults, showing all root faults, and showing an initial critical fault.

4. The system for rapidly diagnosing bugs of system software as claimed in claim 3, wherein when a plurality of faults appears in a single program task, the initial fault is taken as a critical fault for the single program task.

5. A method for rapidly diagnosing bugs of system software, applicable for rapidly localizing a system program fault that causes a system error and then feeding back to a subscriber, the method comprising:
presetting and writing a program of system fault analysis standard into the system;
adding a plurality of fault insertion points into a program module of the system according to the requirement for the precision of the fault analysis result;
generating fault management information at the fault insertion points during a running process of a system program;
monitoring the fault management information, and collecting relevant system fault data;
analyzing in real time the collected system fault data through the program of system fault analysis standard, so as to obtain a minimum fault set for causing the system error; and
recording the minimum fault set into the system log in real time, and feeding back to the subscriber.

6. The method for rapidly diagnosing bugs of system software as claimed in claim 5, further comprising:
grouping a plurality of program tasks running in the system;
sorting and gathering the fault data collected at the fault insertion points according to different groups of the program tasks, and obtaining a minimum fault set for a single task according to the system fault analysis standard; and
filtering and selecting a minimum fault set for the current system according to the system fault analysis standard based upon a topological structure of call relation among the program tasks in the system and the analysis result of the minimum fault set for each single task.

7. The method for rapidly diagnosing bugs of system software as claimed in claim 5, wherein the system fault analysis standard is: showing all relevant faults, showing all root faults, and showing an initial critical fault.

8. The method for rapidly diagnosing bugs of system software as claimed in claim 7, wherein when a plurality of faults appears in a single program task, the initial fault is taken as a critical fault for the single program task.
